(19) United States
(12) Patent Application Publication
(10) Pub. No.: US 2008/0101851 A1
(43) Pub. Date: May 1, 2008

(54) Folder for filing

(75) Inventor: Yoshihiro Shimanaka, Amagasaki-shi (JP)

Correspondence Address: BIRCH STEWART KOLASCH & BIRCH, PO BOX 747, FALLS CHURCH, VA, 22040-0747, US

(73) Assignee: Cosmicdyne International Corporation

(21) Appl. No.: 11/585,854

(22) Filed: Oct. 25, 2006

(51) Int. Cl. B42F 13/12

(52) U.S. Cl. 402/70

(57) ABSTRACT

A folder (2) for filing is constituted to be accommodated in a file having two bars, and includes a restricting portion (4) for restricting a paper, and a hook portion (6) connected to a rear part of the restricting portion (4). The hook portion (6) is connected to the rear part of the restricting portion (4). The hook portion (6) includes a longitudinal guide (8) extended in a longitudinal direction from an edge (14) of the hook portion (6) and a lateral guide (10) extended forward from the other edge (14) of the hook portion (6). The longitudinal guide (8) is fitted in one of the bars and the hook portion (6) is thus rotated around the bar so that the lateral guide (10) can be fitted in the other bar.

### BACKGROUND OF THE INVENTION

1. Field of the Invention

The present invention relates to a folder to be used for arranging papers and holding them in a file.

2. Description of the Related Art

In order to arrange and store papers, a file is used. The file comprises a backbone, a front cover connected to one of side edges of the backbone, a back cover connected to the other side edge of the backbone, and a holding tool disposed on an inside of the backbone. The holding tool includes two bars and opening/closing member. These bars are extended in a direction of a thickness of a paper to be held in the file and are arranged in a longitudinal direction. The opening/closing member carries out a control for pulling in/out and holding papers. When the opening/closing member is opened, the bar can be inserted into a hole provided on a binding margin of the paper. When the opening/closing member is closed, the paper can be held by the holding tool.

When a paper is to be held in a file, a hole is first formed on a binding margin of the paper by means of a paper punch. Next, the opening/closing member is opened to insert the bar into the hole. When the paper is completely accommodated, the opening/closing member is closed. Thus, the paper is held in the file. The file including the bar taking a shape of a ring is referred to as a file of a ring type. A file having the bar constituted by a pipe and a pin capable of being inserted into the pipe is referred to as a file of a pipe type.

In order to take a necessary paper out of the file, all papers arranged just above the necessary paper are to be taken out. In the file, a great deal of time and labor is required for taking out the necessary paper. When the paper thus taken out is accommodated in the file again, the bar is to be inserted into holes of all the papers. In the file, a great deal of time and labor is also required for accommodating the paper which is taken out.

Japanese Laid-Open Utility Model Publication No. 61-105182 has disclosed a stationery of a removable clip type for filing which considers the easiness to take out papers held in a file. Japanese Laid-Open Patent Publication No. 2004-209677 has disclosed a paper holding tool for filing.

In order to hold a paper in a file, it is necessary to form a hole on a binding margin of the paper to be filed as described above. The hole is formed on the paper so that a part of contents described in the paper lacks in some cases.

As described above, the bar of the holding tool is inserted into the hole of the paper so that the paper is held in a file. An edge of the hole comes in contact with the bar of the holding tool. In some cases, the hole is broken due to the contact so that the paper is damaged.

In the stationery of a removable clip type for filing described in the Japanese Laid-Open Utility Model Publication No. 61-105182, a paper can easily be taken out of a file. However, the paper is to be fixed to the stationery with a paste or by means of an engagement needle. A great deal of time and labor is required for fixing the paper to the stationery.

The paper holding tool for filing described in the Japanese Laid-Open Patent Publication No. 2004-209677 comprises a support member including, in an upper part, a receiving surface for receiving a side edge of a paper to be held. The support member includes an end guide for aligning a corner portion of the paper with an end thereof, and a pair of side guides for supporting a paper surface at a side edge thereof. In the holding tool, a distance between both of the side guides is not changed depending on a thickness of the paper but is constant. The number of the papers is properly varied depending on contents thereof. In some cases in which the paper is to be filed depending on the contents by using the holding tool, accordingly, the holding tool is not filled with the papers due to a small number of papers. Such a holding tool has a poor accommodation efficiency for the paper.

The holding tool includes interposing member for interposing the paper, holding member for holding a rocking piece of the interposing member in an opening state, and engaging member having such a structure that the holding tool can be removably engaged with a file in addition to the support member. The number of members constituting the holding tool is large. Accordingly, a production cost of the holding tool is high. Such a holding tool has a poor versatility.

It is an object of the present invention to provide a folder for filing which can hold a paper in a file without forming a hole on the paper.

### SUMMARY OF THE INVENTION

A folder for filing according to the present invention is constituted to be accommodated in a file including two bars and comprises a restricting portion for restricting a paper, and a hook portion connected to a rear part of the restricting portion. The hook portion includes a longitudinal guide extended in a longitudinal direction from an edge of the hook portion and a lateral guide extended forward from the other edge of the hook portion. The longitudinal guide is fitted in one of the bars and the hook portion is thus rotated around the bar so that the lateral guide can be fitted in the other bar.

It is preferable that the lateral guide should include a bottom edge and a pair of side edges extended rearward from an end of the bottom edge in the folder. The side edge takes a convex shape in a direction of extension of the longitudinal guide.

It is preferable that the restricting portion should include two plates and elastic member in the folder. These plates are disposed in such a manner that internal surfaces thereof face each other. The elastic member can apply a force in such a direction that the internal surface of one of the plates and that of the other plate are caused to come in contact with each other.

The folder for filing comprises the hook portion and the restricting portion. In the folder, the number of the members constituting the folder is small. Therefore, a production cost can be reduced. The folder is excellent in a versatility. The hook portion has the longitudinal guide and the lateral guide. In the folder, the restricting portion restricts a paper so that the hook portion can be hung and fixed to the file. For this reason, it is not necessary to form a hole on the paper. The file has two bars. When these bars are extended in a direction of a thickness of the paper to be held in the file and are simultaneously arranged in a vertical direction, the longitudinal guide is fitted in one of the bars and the hook portion is rotated around one of the bars so that the lateral guide can be fitted in the other bar. The folder can easily be hung and fixed to the file.

### BRIEF DESCRIPTION OF THE DRAWINGS

FIG. 1(a) is a side view showing a folder for filing according to an embodiment of the present invention,

FIG. 1(b) is a bottom view showing the folder,

FIG. 2 is a perspective view showing a situation in which the folder in FIG. 1 is used,

FIG. 3 is a partially enlarged perspective view of FIG. 2,

FIG. 4 is a schematic side view showing a situation in which the folder is fitted in a holding tool for a file, and

FIG. 5 is a side view showing a folder for filing according to another embodiment of the present invention.

### DESCRIPTION OF THE PREFERRED EMBODIMENTS

The present invention will be described below in detail based on preferred embodiments with reference to the accompanying drawings.

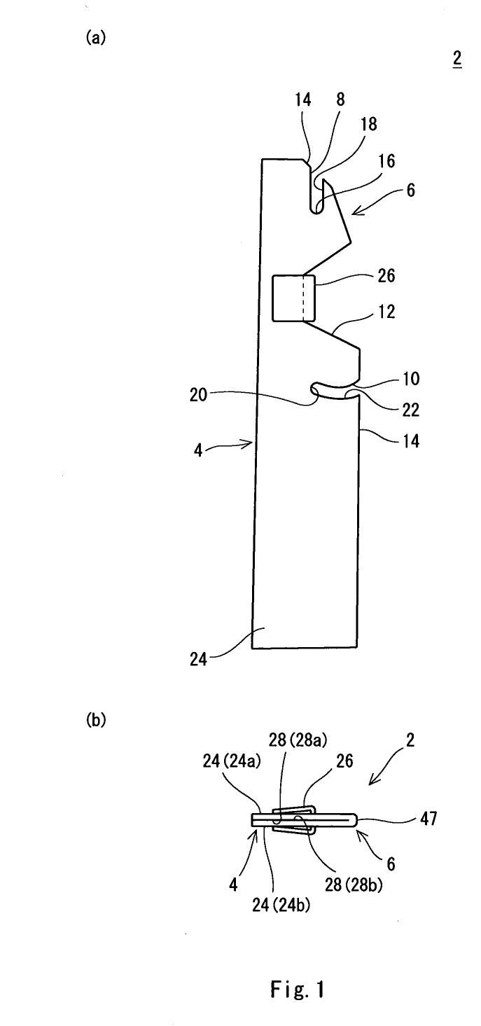

A folder 2 for filing shown in FIG. 1 comprises a restricting portion 4 and a hook portion 6.

The hook portion 6 is positioned behind the restricting portion 4. The hook portion 6 is connected to the restricting portion 4. The hook portion 6 includes a longitudinal guide 8, a lateral guide 10 and a notch 12.

The longitudinal guide 8 is extended downward from an upper edge 14 of the hook portion 6. In other words, the longitudinal guide 8 is extended in a longitudinal direction. The longitudinal guide 8 includes a bottom edge 16 and a pair of side edges 18 extended upward from the bottom edge 16. In the folder 2, the side edge 18 is extended straight. The bottom edge 16 has a contour taking a shape of a circular arc.

The lateral guide 10 is extended forward from the rear edge 14 of the hook portion 6. In other words, the lateral guide 10 is extended forward from the other edge 14 of the hook portion 6. The lateral guide 10 includes a bottom edge 20 and a pair of side edges 22 extended rearward from the bottom edge 20. In the folder 2, the side edge 22 takes a downward convex shape. In other words, the side edge 22 is convex in a direction of the extension of the longitudinal guide 8. The bottom edge 20 has a contour taking a shape of a circular arc.

The notch 12 is positioned between the longitudinal guide 8 and the lateral guide 10. The notch 12 takes a concave shape from a rear edge 14 of the hook portion 6 toward the restricting portion 4.

The restricting portion 4 includes two plates 24 and a clip 26 to be elastic member. These plates 24 take a long shape in a vertical direction thereof. These plates 24 take identical shapes to each other. The plates 24 are disposed to overlap each other. Internal surfaces 28 of the plates 24 face each other.

The clip 26 is a slide clip put on the market. The clip 26 is disposed to interpose the two plates 24 in the vicinity of the notch 12 of the hook portion 6. The clip 26 applies a force in such a direction as to cause an internal surface 28a of a plate 24a to come in contact with an internal surface 28b of a plate 24b. Examples of the clip 26 include a gem clip, a power clip and a double clip in addition to the slide clip.

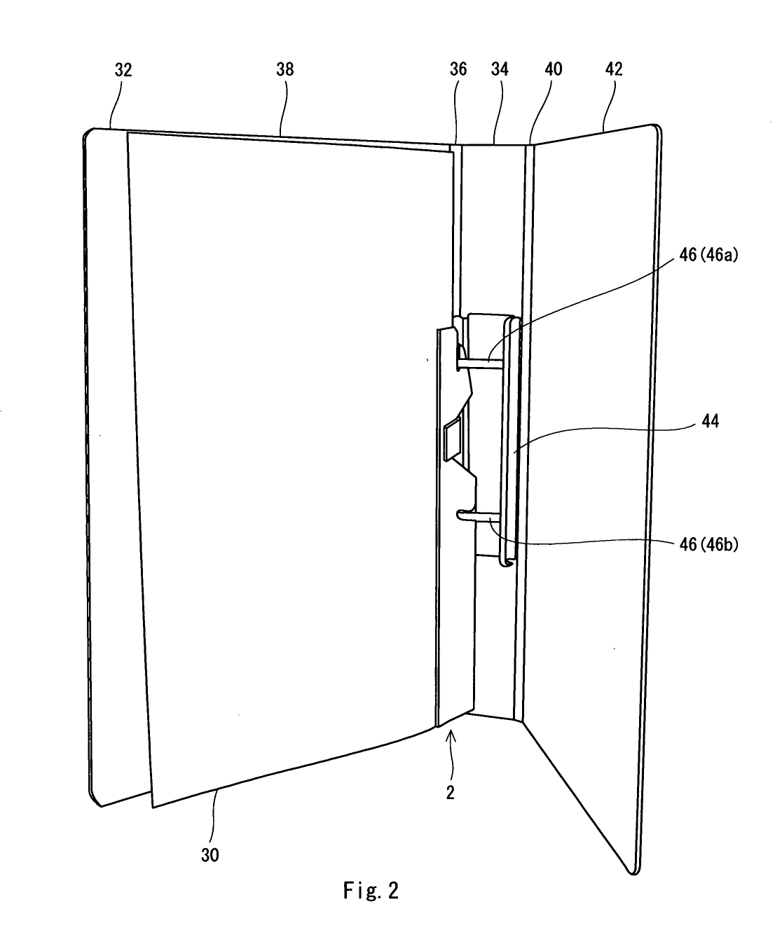

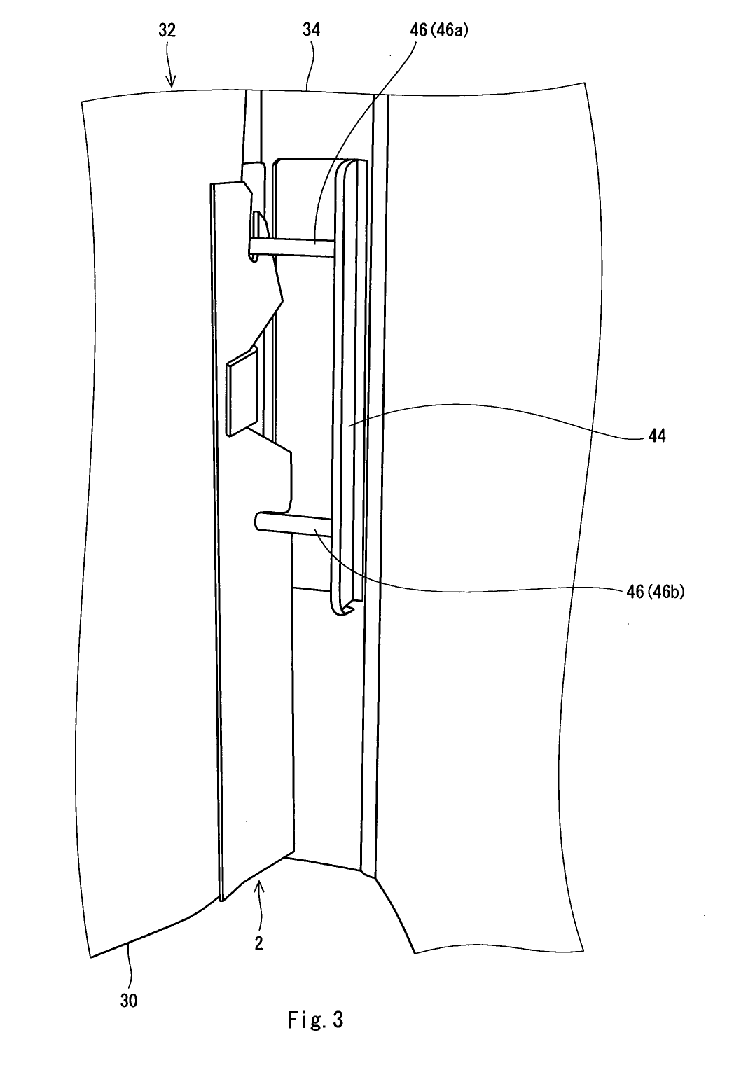

FIG. 2 is a perspective view showing a situation in which the folder 2 in FIG. 1 is used. FIG. 3 is a partially enlarged perspective view of FIG. 2. FIGS. 2 and 3 show the folder 2, a paper 30 and a file 32. As shown, the folder 2 is accommodated in the file 32.

The file 32 includes a backbone 34, a front cover 38 connected to a side edge 36 of the backbone 34, a back cover 42 connected to a side edge 40 of the backbone 34, and a holding tool 44 disposed on an inside of the backbone 34. The holding tool 44 has two bars 46. These bars 46 are extended in a direction of a thickness of the paper 30 to be held in the file 32 and are arranged in a longitudinal direction. The bar 46 is constituted by a pipe and a pin which can be inserted into the pipe, which is not shown. The file 32 is of a pipe type. The file 32 is a tool for filing the paper 30. Examples of the paper 30 to be held in the file 32 include documents, forms, drawings, brochures and the like. The file 32 is provided with opening/closing member for carrying out a control to put in/out the paper 30 and to hold the paper 30, which is not shown.

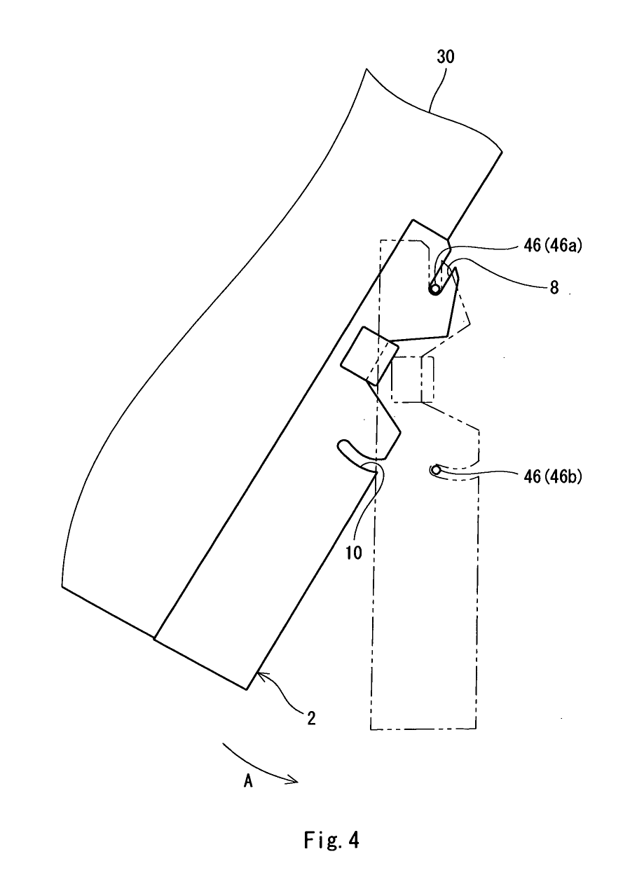

FIG. 4 is a schematic side view showing a situation in which the folder 2 is fitted in the holding tool 44 of the file 32. FIG. 4 shows the folder 2, the paper 30 and the bar 46 provided on the holding tool 44 of the file 32. In FIG. 4, an arrow line A represents a direction of rotation of the folder 2.

A method of using the folder 2 is as follows. First of all, the clip 26 is removed from the folder 2. Consequently, a clearance is formed between the two plates 24. Next, the paper 30 is inserted into the clearance. Thus, a binding margin of the paper 30 is interposed between the two plates 24. Then, the clip 26 is fitted in the plate 24. Consequently, the paper 30 is restricted by the restricting portion 4. Then, the longitudinal guide 8 is fitted in an upper bar 46a. Thereafter, the hook portion 6 is rotated toward the holding tool 44 around the upper bar 46a. The lateral guide 10 can be fitted in a lower bar 46b by the rotation. Thus, the hook portion 6 can be hung and fixed to the holding tool 44. The folder 2 can easily be hung and fixed to the file 32 without using the opening/closing member of the file 32.

The lateral guide 10 is pulled out of the lower bar 46b and the hook portion 6 is then pulled forward, obliquely and downward so that the folder 2 hung and fixed to the holding tool 44 can easily be removed from the holding tool 44. Also in the removal of the folder 2, it is not necessary to use the opening/closing member of the file 32. The folder 2 can easily accommodate the paper 30 in the file 32. The folder 2 can easily remove the paper 30 from the file 32.

A plurality of holders 2 can be hung and fixed to the holding tool 44 of one file 32. In the case in which the paper 30 is accommodated in the file 32 by using the folder 2, a user can take only the folder 2 restricting the necessary paper 30 from the file 32. By using the folder 2, the user can easily take the necessary paper 30 from the file 32.

When the paper 30 is to be held in the folder 2, the clip 26 applies a force in such a direction that the internal surface 28a of the plate 24a is caused to come in contact with the internal surface 28b of the plate 24b. Accordingly, the paper 30 does not slip from the restricting portion 4. In the folder 2, it is not necessary to form a hole on the paper 30 in order to restrict the paper 30. When the clip 26 is removed from the plate 24, the paper 30 is released from the restricting state. Therefore, the paper 30 can easily be taken out of the folder 2.

When the paper 30 is held in the file 32 by using the folder 2, a dead weight of the paper 30 acts on the folder 2. By the dead weight of the paper 30, a force acts to incline the folder 2 forward around the vicinity of the bottom edge 20 of the lateral guide 10 fitted in the lower bar 46b. Since the longitudinal guide 8 is extended in a longitudinal direction in the folder 2 as described above, it is prevented from being removed from the upper bar 46a. The folder 2 can be reliably hung and fixed to the holding tool 44.

As shown in FIG. 1, the side edge 22 of the lateral guide 10 takes a downward convex shape in the folder 2. It is not easy to forward pull the lateral guide 10 out. The lateral guide 10 is prevented from suddenly slipping from the bar 46b. The folder 2 can be reliably hung and fixed to the holding tool 44. In order to prevent the lateral guide 10 from being forward pulled out, a wedge-shaped projection may be provided between the bottom edge 16 and the side edge 22 in the lateral guide 10.

The folder 2 is obtained by bending one sheet and cutting the sheet to take a predetermined shape and then fitting a slide clip therein. The folder 2 can easily be produced. Since a small number of members constitute the folder 2, a production cost of the folder 2 is low. The folder 2 is excellent in a versatility.

In the folder 2, a torsion coil spring to be elastic member may be provided between the restricting portion 4 and the hook portion 6. As shown in FIG. 1(b), a fold-back portion 47 of a sheet is formed in the hook portion 6 of the folder 2. In such a folder 2, the torsion coil spring may be provided in the fold-back portion 47.

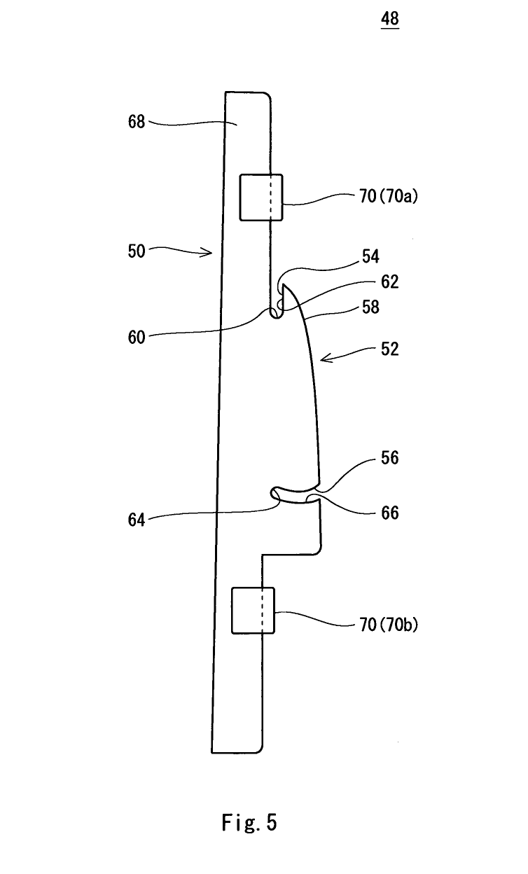

FIG. 5 is a side view showing a folder 48 for filing according to another embodiment of the present invention. The folder 48 includes a restricting portion 50 and a hook portion 52.

The hook portion 52 is positioned behind the restricting portion 50. The hook portion 52 is connected to the restricting portion 50. The hook portion 52 includes a longitudinal guide 54 and a lateral guide 56.

The longitudinal guide 54 is extended downward from an upper edge 58 of the hook portion 52. The longitudinal guide 54 includes a bottom edge 60 and a pair of side edges 62 extended upward from the bottom edge 60. In the folder 48, the side edge 62 is extended straight. The bottom edge 60 has a contour taking a shape of a circular arc.

The lateral guide 56 is extended forward from a rear edge 58 of the hook portion 52. The lateral guide 56 includes a bottom edge 64 and a pair of side edges 66 extended rearward from the bottom edge 64. In the folder 48, the side edge 66 takes a downward convex shape. The bottom edge 64 has a contour taking a shape of a circular arc.

The restricting portion 50 takes a long shape in a vertical direction thereof. The restricting portion 50 takes a rectangular shape. The restricting portion 50 includes two plates 68 and a pair of clips 70 to be elastic member. These plates 68 take identical shapes to each other. These plates 68 are disposed to overlap each other. Accordingly, internal surfaces of these plates 68 face each other. The folder 48 has the hook portion 52 provided in the vicinity of a center of the restricting portion 50.

In the folder 48, a clip 70a is disposed on an upper side of the hook portion 52. A clip 70b is disposed on a lower side of the hook portion 52. The clip 70 interposes two plates 68.

In the restricting portion 50 of the folder 48, papers are interposed between the plates 68, which is not shown. The clip 70 interposes the plates 68. The clip 70 applies a force in such a direction that an internal surface of one of the plates 68 and that of the other plate 68 are caused to come in contact with each other. Accordingly, the papers do not slip from the restricting portion 50. In the folder 48, it is not necessary to form a hole on the paper in order to restrict the paper. When the clip 70 is removed from the plate 68, the papers are released from the restricting state. Therefore, the papers can be removed from the folder 48.

When the folder 48 is hung and fixed to the same file as the file 32 to which the folder 2 shown in FIG. 1 is hung and fixed, the longitudinal guide 54 of the folder 48 is fitted into an upper bar. Next, the hook portion 52 is rotated toward a holding tool of the file around the upper bar. The lateral guide 56 can be fitted into a lower bar by the rotation. The folder 48 can easily be hung and fixed to the holding tool without using opening/closing member for the file.

The lateral guide 56 is pulled out of the lower bar and the hook portion 52 is then pulled forward, obliquely and downward so that the folder 48 hung and fixed to the holding tool can easily be removed from the holding tool. Also in the removal of the folder 48, it is not necessary to use the opening/closing member of the file. The folder 48 can easily accommodate the paper in the file. The folder 48 can easily remove the paper from the file.

A plurality of holders 48 can be hung and fixed to the holding tool for one file. In the case in which the paper is accommodated in the file by using the folder 48, a user can take only the folder 48 restricting the necessary paper from the file. By using the folder 48, the user can easily take the necessary paper from the file.

When the paper is held in the file by using the folder 48, a dead weight of the paper acts on the folder 48. By the dead weight of the paper, a force acts to incline the folder 48 forward around the vicinity of a bottom edge 60 of the lateral guide 56 fitted in the lower bar. Since the longitudinal guide 54 is extended in a longitudinal direction in the folder 48 as described above, it is prevented from being removed from an upper bar 46. The folder 48 can be stably hung and fixed to the holding tool.

As shown in FIG. 5, the side edge 66 of the lateral guide 56 takes a downward convex shape in the folder 48. It is not easy to forward pull the lateral guide 56 out. The lateral guide 56 is prevented from suddenly slipping from the bar. The folder 48 can be stably hung and fixed to the holding tool.

The above description is only illustrative and various changes can be made without departing from the scope of the present invention.

What is claimed is:

1. A folder for filing which is constituted to be accommodated in a file including two bars, comprising:
a restricting portion for restricting a paper; and
a hook portion connected to a rear part of the restricting portion,
wherein the hook portion includes a longitudinal guide extended in a longitudinal direction from an edge of the hook portion and a lateral guide extended forward from the other edge of the hook portion, and
the longitudinal guide is fitted in one of the bars and the hook portion is thus rotated around the bar so that the lateral guide can be fitted in the other bar.

2. The folder according to claim 1, wherein the lateral guide includes a bottom edge and a pair of side edges extended rearward from an end of the bottom edge, and
the side edge takes a convex shape in a direction of extension of the longitudinal guide.

3. The folder according to claim 1, wherein the restricting portion includes two plates and elastic member,
the plates are disposed in such a manner that internal surfaces thereof face each other, and
the elastic member can apply a force in such a direction that the internal surface of one of the plates and that of the other plate are caused to come in contact with each other.
